(19) United States
(12) Patent Application Publication
(10) Pub. No.: US 2015/0227949 A1
(43) Pub. Date: Aug. 13, 2015

(54) Active feedback management system in physical world

(71) Applicant: Jesal Sangani, Quincy, MA (US)

(72) Inventor: Jesal Sangani, Quincy, MA (US)

(21) Appl. No.: 14/547,095

(22) Filed: Nov. 18, 2014

Related U.S. Application Data
(60) Provisional application No. 61/905,831, filed on Nov. 18, 2013.

(51) Int. Cl. G06Q 30/02; H04W 4/02

(52) U.S. Cl. CPC G06Q 30/0201; G06Q 30/0282; H04W 4/02

(57) ABSTRACT

A networked application system includes a plurality of user front-end devices each operating a user front-end application and a plurality of provider front-end devices each operating a provider front-end application. A networked back-end operates to interface with the user front-end application of each of the plurality of user front-end devices and with the provider front-end application of each of the plurality of provider devices. A user of the user front-end application is uniquely identified by a user ID. A goods and services provider is uniquely associated each provider front end device and the provider site where the provider front end device is operated is known. The networked back-end operates to monitor each of the plurality of user front-end devices, and each of the plurality of provider front-end devices in order to detect triggering events such as interactions between user device users and a provider sites.

### CROSS REFERENCE TO PRIOR APPLICATIONS

This application claims priority under 35 U.S.C. 119(e) based upon Provisional Application Ser. No. 61/905,831 entitled Active Feedback Management System in Physical World, filed Nov. 18, 2013 which is incorporated herein by reference in its entirety.

### COPYRIGHT STATEMENT

A portion of the disclosure of this patent application 5 document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The disclosure relates to a network-based Active Feedback Management System (AFMS) operable to request real-time feedback from users or customers consuming goods and services provided by goods and service providers. The feedback requested is based on personal and or situational information and may be specifically targeted at obtaining user feedback about a specific product, a specific physical amenity or a specific service. More specifically the present disclosure relates to a method of collecting and gathering pertinent information from a user device, and matching that information with database records that relate to the user and or to goods and services recently purchased by or otherwise experienced by the user.

2. Description of the Prior Art

Presently, many companies request customer feedback about their services or their products through e-mail, mail, telephonic surveys, web surveys, or the like. Usually the customer feedback request occurs long after the customer has purchased or consumed the goods and services. Other customer feedback information is acquired during the course of purchasing or registering to use the services or products purchased. For example, JetBlue airlines requests feedback on flights via e-mail to folks who have recently flown and used their e-mail as a mechanism to receive electronic information of flight details and airline ticket. JetBlue has access to the information that the user provided as a way of requesting the feedback. Similarly, hotel chains like Hyatt or Marriot request similar feedback on recent stays. However, this feedback often comes days after the trip or stay and the questions to be asked are often broad or not specific enough.

Other platforms that exist for giving feedback include rankings or comments entered by users, such as YELP. These platforms work based on users voluntarily providing feedback and rankings. However these voluntary entries are unreliable because in some cases they are anonymous and therefore not completely trustworthy, e.g. they may include false good and bad rankings entered by biased individuals. Otherwise voluntary anonymous feedback can be biased when users only rank the business for the best and worst experiences and fail to provide regular feedback, e.g. when the experience was neither extremely good nor extremely bad. Additionally feedback on YELP and other network based performance voluntary business evaluation systems may be limited to certain demographic groups, e.g. ages 19-30. A further problem with conventional business feedback surveys is that the questions are non-specific, e.g. they are not about a specific product or service but instead about the overall shopping experience. As a result a small unfavorable incident could cause a customer to rank the entire purchasing event as unsatisfactory when the customer was actually happy with all but one part of experience.

What is needed is a platform to provide more active real time feedback in response to specific service events and or product purchases. Ideally the platform is operable to determine the identity of the user, the location of the user and situational information such as the user habits or the like so that user feedback questions can be tailored to the users' specific situation to provide more specific feedback about the users' experience.

### SUMMARY OF THE INVENTION

The systems and methods described herein provide a network-based application. The networked application provides goods and services providers with the ability to track user activities, wherein users include consumers, clients, customers, or the like, of the goods and service provider or of affiliates of the goods and service provider. In a first operating mode, the networked application is operable to determine if a user is present at a provider site. In example embodiments the network based application is operable to detect when a user arrives at and when the user departs from a provider site and to report that information to the provider or otherwise record user arrival and departure events in a database. In example embodiments the networked application is operable to determine what goods and services the user interacted with, purchased, or inquired about during a user session, e.g. the period between user arrival at and departure from the provider site. In example embodiments the networked application is operable to generate one or more personalized and/or situational message and or questions to present to the user. The personalized and/or situational messages and or questions may be based on the user's identity and/or current location. The personalized and/or situational messages and or questions may be based on; a user demographic or affiliation, the users' purchasing history and or known preferences or habits of the user, and various other situation information that may be known such as but not limited to the local time of day, the local weather or season, provider site operating hours or local amenities, which staff members have worked with the user before or are currently present at the provider site, earlier message and or questions presented to the user, and answers to those earlier questions. In a preferred embodiment, the personalized and/or situational message and or questions comprise survey questions aimed at obtaining real time user feedback about specific user encounters with elements of the provider site, about the quality of the goods and services being provided about the performance of the local staff and any about potential improvements and or additional goods and services that the user may desire or suggest.

In a preferred embodiment, a personalized and/or situational message or question is presented to the user or scheduled to be presented to the user as soon as the networked application detects a triggering event. The triggering event may include a user arrival or check-in at a provider site, a user departure or check-out from a provider site, a user making a purchase, placing an order, making a reservation, changing an order or reservation, or the like, a user inquiry entered into a user front end or a user web portal, a user arriving at a geo-location corresponding to a provider site or a specific geo-location within the provider site, any interaction with a user detected on a provider front-end device or otherwise recorded or detected by the networked application. In one non-limiting example operating mode a plurality of triggering events occurs during a user session. For each triggering event or selected triggering events the networked application is operable to generate and transmit one or more personalized and/or situational messages or questions to the user wherein the content of the messages and or questions is relevant to the triggering event. Preferably, one or small number of personalized and/or situational messages or questions related to a single triggering event is sent to the user in order to specifically focus the communication on the single triggering event. As a result when a user answers one or a small number of questions that relate to only one triggering event the user feedback specifically relates to one triggering event and is less likely to bias by the overall user session experience. The networked application is operable to track user messages and questions as well as user responses to the questions and to sort user response by triggering event.

In certain aspects each user operates a user front-end application (1005) on a smart phone or other telecommunications device (2000) shown in FIG. 2. The telecommunications device (2000) may belong to the user, however providers may places telecommunications devices (2000) operating the user front-end application (1005 ) at provider sites so that any user or any user with a log in account can access the networked application of the present invention. The user front-end application (1005) is operable to display a user log in screens, user profile screens, and other screens relating the user in a manner that allows the user to update or add personal information and preferences to the user profile. User personal information may be entered by the user or the user may authorize the networked application of the present invention to access user profile information, either already stored on the networked application of the present invention or on other networked applications such as may be available by network access, e.g. from a social media network organization, e.g. Facebook or Twitter or the like, or from other networking applications e.g. smart phone service providers, internet access providers, or the like, that already store personal information about the user.

In certain aspects, a user may allow the user front-end application (1005) to track the user geo-location and transmit geo-locational information to the networked application. In such cases the networked application is operable to compare the user geo-location with the geo-location of goods and service provider sites and/or specific areas of goods and services provider sites. Additionally the networked application is operable to inform a provider of goods and services that a user is present at the provider site, such as by transmitting an automatically generated message to a provider front-end application (1010) of the present invention. Additionally, the networked application is operable to acknowledge the presence site by generating an automated message for transmittal to a user.

In other operating modes the networked application is operable to allow an operator of the provider front-end application (1010) to compose a user message, or to select an appropriate pre-composed user message for transmittal to the user in response to a triggering event. The user message is transmitted to the user front-end application (1005) and displayed to the user on a user front-end device. In some instances, the networked application is operable to prompt the service provider to send a welcoming, goodbye message, or other message to the user. The message content is situational and is dependent upon what type of triggering event has occurred. Example triggering events include user X has arrived, user X just purchase product Y, user X is watching the World Series game in the lounge. In one operating mode message content is pre-composed and automatically transmitted to the user front end application (1005) and reported to the provider front-end application. In other operating modes message content is pre-composed by requires further action by the provider. The further action by the provider may include reviewing the pre-composed message and then approving transmission to the user, altering the pre-composed message and then approving transmission to the user or composing a new message and then approving transmission to the user. In certain aspects, the systems and methods described herein include an active network application comprising one or more network based servers comprising storage or memory modules and digital data processing devices and circuitry and network interface devices operable to provide data and communication service to providers of good and services and users or customers of the providers of goods and services. The digital data processing devices include program instructions operating thereon to retrieve user input data, such as a user profile, a user shopping history, or the like, from the storage or memory modules, to receive user location information from device user devices carried or operated by the user, to track user triggering events during a user session, to select and or compose personalized messages and or personal or situational questions to transmit to users, wherein the message content relates to situational information associated with the triggering event. Additionally the digital data processing devices and program instructions operating thereon are operable to record user responses to questions, relate the user responses to each question to a triggering event and to compile user responses in reposts or the like. Additionally the digital data processing devices and program instructions operating thereon are usable to determine whether a user response to a question or other input warrants prompt action by the provider to correct a problem or other dissatisfaction identified by the user. The digital data processing devices and program instructions further operate to store user questions and responses in the memory modules such as in a database.

In certain approaches, the processing circuitry of the digital data processing devices and program instructions may operate to make offers to users. In one example the digital data processing devices and program instructions may identify that a particular user is a repeat customer and based on a pre-determined metric or a service provider recommendation the digital data processing devices and program instructions may authorize and or transmit offers to a user. For example, the processing circuitry of the digital data processing devices and program instructions may be configured to determine that a particular user has frequented their hotel 6 times in the past two months and make an offer or authorize that an offer can be made to a user to receive an upgrade upon arrival to one of the service provider's hotels.

In certain embodiments, a user may return to a particular provider restaurant within a week after a recent visit and the processing circuitry of the digital data processing devices and program instructions may prompt the user or a provider staff member that the user is eligible for an offer for a free drink, or the like, during that visit.

In certain approaches, the processing circuitry of the digital data processing devices and program instructions may be further configured to provide information to the service provider of the busiest times of the day, week, month or year and the associated demographics of users associated with certain times.

In certain embodiments, an app (or application) is pre-installed on a user's own mobile device and detects when the user has entered a service provider site or a particular part of service provider's site.

In certain embodiments, a scanable code a kiosk or other user interface device is located on a surface such as a wall of a gym or swimming to pool located at a service provider site to which the user may scan said code (barcode, QR, etc.) or operate the kiosk and be prompted for user feedback through a user front-end application operable on the users mobile device or a user device provided at the location by the goods and services provider. Information may be sent directly to a provider site manager or multiple sources. For example, the swimming pool has a dead frog in it and the user either opens the user front-end application or scans swimming pool code to notify the service provider of the dead frog situation. A determination of the type of problem then directly sends information to one or more parties such as facilities maintenance workers and hotel manager.

In certain embodiments, a scanable code is located on a surface of or otherwise associated with a product sold by a provider such as a Universal Product Code (UPC) on a soap/drink, etc. to which the user may scan said code (barcode, QR, etc.) and be prompted for user feedback through a user portal such as the user front-end application operating on a user front-end device. Information may be sent directly to a goods and services provider manager or staff member or sent to multiple other designated network based resources such as the product Manufacturer, a distributor or other 3^{rd} party product or service provider. For example, the bartender has served a bad beer to a user and the user interfaces with the user front-end application to scan or photograph the UPC barcode and report the issue. Thereafter the networked application or the present invention takes various actions to notify the goods and services provider of the issue and to record details of the incident in the memory module. In doing so, the networked application may determination the type of problem then directly send information to one or more goods and service provider staff such bar facilities maintenance workers, a bar manager and or to the beer manufacturer or distributor. Additionally, the networked application may operate to make the user an offer, e.g. for a free beer or other compensation.

These and other embodiments are described in more detail herein.

TERMS

| Term | Usage |
|---|---|
| Feedback management system | Operator of the active feedback management |
| operator | system. |
| Active feedback management | A collection of distributed telecommunications |
| system | devices operable to manage interactions |
| | between a user or customer and a goods and |
| | services provider. |
| User | Anyone that purchases goods and/or services |
| | from the goods and services provider. |
| Provider | A goods and services provider |
| Provider site | A physical location or setting where a user |
| | interacts with a provider to purchase or |
| | consume goods and services. |
| User device | A telecommunications device that includes an |
| | element of the feedback management system |
| | operating thereon for the benefit of the user. |
| Provider device | A telecommunications device that includes an |
| | element of the feedback management system |
| | operating thereon for the benefit of the |
| | provider. |
| User session | A period during which the user and the |
| | provider are engaged in an exchange of goods |
| | and services. |
| User specific information | Information that relates to a specific user and |
| | or a user demographic |
| Situational information | Information that relates to a current or near |
| | current situation of the user, the provider or the |
| | provider site. |

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 depicts a block diagram depicting a non-limiting exemplary network architecture suitable for facilitating active communication between a user and a provider according to the present invention.

FIG. 2 depicts a block diagram showing an exemplary non-limiting telecommunications device useable as a user front-end device or a provider front-end device according to the present invention.

FIG. 3 depicts a block diagram showing exemplary non-limiting system architecture of a user front-end device according to the present invention.

FIG. 4 depicts a block diagram showing exemplary non-limiting system architecture of a provider front-end device according to the present invention.

FIG. 5 depicts a block diagram showing exemplary non-limiting network device structure suitable for servicing a single user and a single goods and services provider according to the present invention.

### DETAILED DESCRIPTION OF THE PREFERRED EMBODIMENT

### Overview

An Active Feedback Management System (AFMS) (1000) of the present invention operates to facilitate active communication between users or consumers of goods and services and providers of goods and services. The AFMS (1000) is provided and operated by a feedback management system operator. The feedback management system operator provides a user front-end application (1005) to users for operation on a user front-end device (1015) such as a smart phone or tablet; however any telecommunication device is potentially usable as a user front-end device (1015). The feedback management system operator provides a provider front-end application (1010) to providers of goods and services for operation on one or more a provider front-end devices (1020) such as a provider business management system, point of sale system or the like.

Each user opts in to active feedback management services provided by the feedback management system operator by loading the user front-end application (1010) onto the users' own personal user front-end device (1015). The provider of goods and services opts in to the services provided by the feedback management system operator by loading the provider front-end application onto a provider front-end device (1020) such as the provider's business management system or other telecommunication enabled front-end devices. Additionally each provider works with the by the feedback management system operator to populate feedback management system databases with a list of provider site locations, with lists of goods and services provided, with pricing information, a list of customers or users, and with various aspects of the providers' business that the provider would like to receive real-time feedback about.

The feedback management system provider establishes and maintains a networked application that includes a networked back-end (1025). The networked back-end (1025) includes a user application server (1040) configured to communicate with users operating the user front-end application (1005) on a user front-end device (1015). The networked back-end (1025) further includes a provider application server (1045) provided to communicate with providers operating the provider front-end application (1010) on one or more provider front-end device (1020). The networked back-end (1025) further includes a database server (1035). The database server (1035) at least stores user information, provider information and historic goods and services purchase transaction records thereon. The database server (1035) may also store other data more generally related to user demographics as they relate purchasing goods and services and more generally as they relate to the sale of goods and services by the providers serviced by the AFMS (1000). Additionally the database server (1035) stores provider information including a listing of providers, provider site locations, including GPS coordinates, goods and services offered by the provider at each provider site, amenities associates with each provider site, process lists, staff lists, directions to provider sites, and other relevant information that is usable to generate situational user questions that specifically relate the user situational questions to actual details of the provider site and provider offerings, amenities and the like.

The user front-end application (1005) provides a user with access to the user application server (1040) over a network. The user application server (1040) communicates with each user over the user front-end application (1005). Additionally the user front-end application (1005) may utilize resources of the user front-end device (1015), e.g. to display messages or menus, or the like, to the user, to receive feedback from the user, e.g. when a user makes a key pad selection in response to a displayed menu, or survey question, to track user location using a global positioning system (GPS) device operating on the user front-end device (1015), to store data on a memory of the user front-end device (1015), or the like.

The provider front end application (1010) provides provider staff members with access to the provider application server (1045). The provider application server (1045) communicates with each provider over the provider front-end application (1010).

In some cases the provider may operate a plurality of provider sites such as a plurality of different provider sites or different point of sale locations within a single provider site. In some cases the provider may operate a plurality of provider divisions or departments either at the same provider site or at different provider sites. In such cases the provider may be operating a plurality of provider front-end devices (1020) such as one or more provider front end devices at each different provider site, at each different provider point of sale location, at each different provider division, in each provider department, or the like, and each of the provider front-end devices (1020) includes a different instance of the provider front-end application (1010) operating thereon.

Generally the AFMS (1000) operates to determine when a user is engaged in a user session wherein the user is actively engaged in a transaction or potential transaction with a particular provider of goods and services. The user session may relate to purchasing or ordering goods and or services from the particular provider, consuming the goods or services, returning goods or services, returning goods or services, canceling or changing an order, making cancelling or changing a reservation. In other applications the user session may include tracking or managing goods and or services after purchase, e.g. for warranty service or follow up after a medical procedure or the like.

In response to determining that the user is engaged in a user session with a particular provider that utilizes the AFMS (1000), the AFMS (1000) operates to determine situational information about the user session. In particular the AFMS (1000), gathers situational information from the user front end application (1005), e.g. the location of the user based on the GPS location of the user front-end device (1015), and if the user is located at a particular provider site the AFMS (1000) operates to gather situational information from the provider front end application (1010) or provider application server (1045). Situational information gathered from the provider front-end application may include but is not limited to whether the user has already made a point of sale purchase, whether the user made a prior reservation, or whether any there are records of recent transactions involving the user recorded on the provider front end application (1010) or provider application server (1045).

Thereafter the back-end (1025) operates to compile situational information that may be helpful to the user, to the provider or to both. Situational information may include but is not limited to the specific identity of the user, the specific identity of the provider, a history of interactions between the user and the provider, goods and services offered by the provider at the provider site where the user is located, goods and services favored by the user, user demographic information, what area of the provider site the user is located at, the local time and operating hours at the provider site, the local weather, whether the provider is aware that the user is present, whether the provider has already had contact with the user, whether the user was expected e.g. did the user make a reservation, or the like. Other situational information may include situational information about the provider site such as active discount programs, or the like, being offered at the provider site, what new or improved product or service offerings are being offered, updates about recent upgrades to the provider site, a list of specific provider personnel that are on duty and that have a relationship with the user, or the like.

Thereafter the AFMS (1000) operates to facilitate communication between the user and the proprietor. User communication is exchanged between the user front-end application (1005) and the user application server (1010). Provider communication is exchanged between the provider front-end (1010) and the provider application server (1045). The provider application server (1045) operates to communicate with the user application server (1010) to exchange information there between and to cooperatively generate user messages, receive responses to user messages from users, to present user responses to the provider in the form of provider messages, reports, or the like, and to track provider activities responsive to the user messages. Both the provider application server (1045) and the user application server (1010) interact with the database server (1035) to retrieve and or store situational information in appropriate database fields. The provider application server (1045) may operate to track user and provider messages and to track further activates or tasks associated with a particular user and or provider message. Additionally the provider front-end (1020) is operable to display a menu of stored user messages or to generate a user message suitable for sending to a user during a user session, wherein the content of the user message is based on situational information, about the user, about the provider, about the provider location or the like.

User messages may include situational statements such as a welcome greeting or some useful situational information about the provider site; e.g. we have moved the gym to the9^{th} floor. Situational statements do not require a response. User messages may include situational requests for feedback. A user request demands that a user input information whether by a key stroke or screen touch to select a menu choice or by entering text data using a key pad or touch screen.

Provider messages may include situational statements such as user X has just been checked in and has been assigned room Y. Provider messages may include situational requests for feedback. A request for feedback. A provider request demands that provider staff input information whether by a key stroke or screen touch entry to select a menu choice or by entering text data using a key pad or touch screen.

The provider front end device (1020) and provider front-end application (1010) are operable with the networked back-end (1025) to suggest user messages having situational message content. The provider front end device (1020) and provider front-end application (1010) are operable with the networked back-end (1025) to display a menu of user message content choices to a provider operator wherein the suggested user message content is at least in part responsive to situational information that relates to the user.

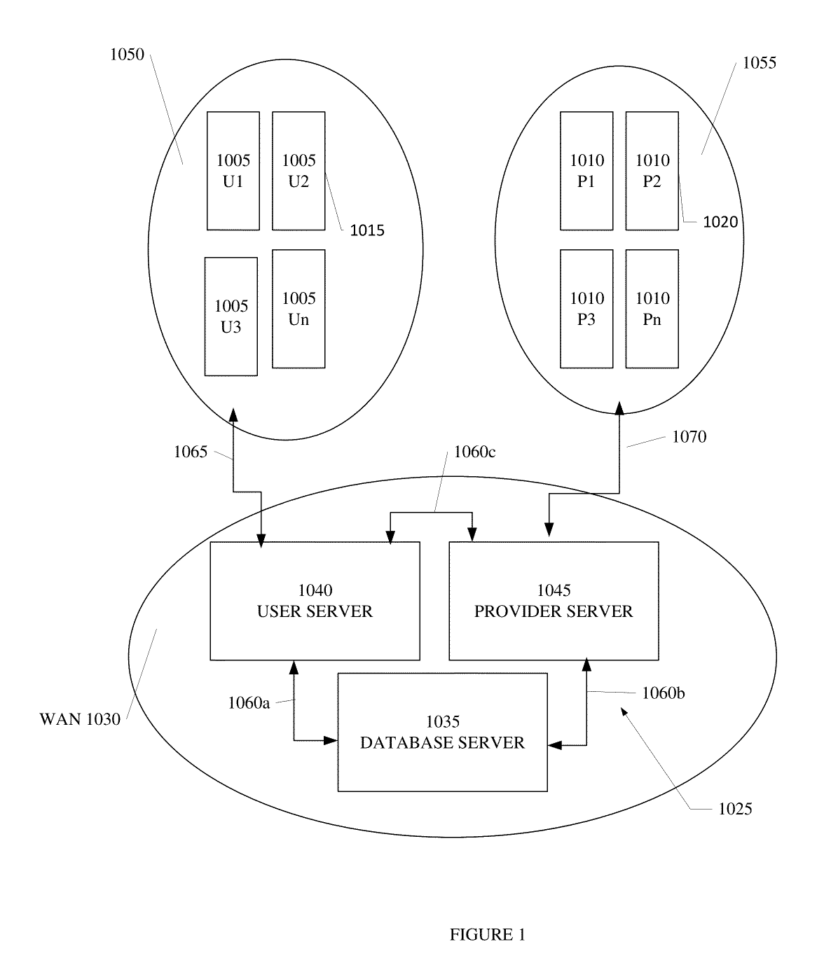

Referring now to FIG. 1 a block diagram depicts an Active Feedback Management System (1000) (AFMS) according to one non-limiting embodiment of the present invention. The AFMS (1000) includes a user front-end application (1005) and a provider front-end application (1010). A single instance of the user front-end application (1005) operates on a single user front-end device (1015). A population of user devices (1050) includes a plurality of user devices (1015) each operating a different instance of the user front end application (1005). Thus a first user front end device (1015) is running a first instance of the user front-end application (1005 U1), a second user front end device (1015) is running a second instance of the user front-end application (1005 U2) and so on through the population of users (1050) wherein the nth user uses user font-end application instance (1005 Un).

Generally a user population (1050) includes a plurality of different users each subscribing to or using services provided by an operator of the Feedback Management System (1000). Each user has a unique identity which is determined when the user interacts with the front-end user application (1005) such as by responding to a prompt to log in. In one non-limiting exemplary user population instance, each user front-end device (1005) belongs to a different user, such as when each user front-end device (1015) is a smart phone owned or operated by the user. However, in another exemplary non-limiting user population model one or more user front-end devices (1005) is provided at a provider site by a provider of goods and services so that any user visiting the provider site can gain to access the user front-end application (1005) to interact with the AFMS (1000). However no matter how a user gains access to the user front-end application (1005), the AFMS (1000) operates to determine a unique user ID for each user and if no user ID is found the AFMS (1000) operates to interact with the user to establish a user ID for the user or to prevent user access to the AFMS (1000).

A single instance of a provider front-end application (1010) operates on a single provider front-end device or system (1020). A population of provider devices or systems (1055) includes a plurality of provider devices or systems (1020) each operating a different instance of the provider front end application (1010). Each provider device or system (1020) is associated with a different provider of goods and services. Thus a first provider front end device (1020) is running a first instance of the provider front-end application (1010 P1), a second provider front end device (1020) is running a second instance of the user front-end application (1010 P2) and so on through the population of providers of goods and services (1055) wherein the nth provider or goods and services uses the provider font-end application instance (1010 Pn).

A provider front-end device population (1055) shows a single provider front-end devices (1020) associated with each distinctly different goods and services provider that utilizes the services of the AFMS (1000). However in most instances the provider utilizes a plurality of provider front end devices (1020) which are distributed throughout a single provider site and/or distributed at a plurality of different provider sites. Each provider has a unique provider-ID such as P1, P1, P3, however when a provider utilizes a plurality of provider front end devices (1020) each provider front end device has its own unique provider device-ID.

The AFMS (1000) includes a networked back-end system (1025) operating a WAN (1030). The networked back-end system (1025) may comprise a virtual private network interconnected by virtual private network tunnels (1060a) (1060b) and (1060c) or the like. The networked back-end system (1025) communicates with each of the user front end devices (1015) over wired and wireless network paths, that may include network legs passing over a cellular network, a wireless local area networks (WLAN), a satellite network, and or a wired network, e.g. Ethernet, cable, fiber optic, DSL and or the like. The networked back-end system (1025) communicates with each of the provider front end devices (1020) over wired and wireless network paths, that may include network legs passing over a cellular network, a wireless local area networks (WLAN), a satellite network, and or a wired network, e.g. Ethernet, cable, fiber optic, DSL and or the like.

In one non-limiting exemplary embodiment, the networked back-end (1025) is configured to provide services to the population (1050) of user front-end devices (1015) by operating a user application server (1040). The networked back-end (1025) is further configured to provide services to the population of providers (1055) by operating a provider application server (1045). The user application server (1040) interacts with the population (1050) of user front-end devices (1015) over user network pathways (1065) which extend from each individual user front-end device (1015) to the user application server (1040). The provider application server (1045) interacts with the population (1055) of provider front end-devices (1020) over provider network pathways (1070) which extend from each individual provider front-end devices (1020) to the provider application server (1045). The networked back-end system (1025) further includes a database server (1035) which serves as an updatable and easily searchable data storage device useable by the user application server (1040) and by the provider application server (1045). As described above each of the application server (1045), the provider server (1045) and the database server (1035) has a unique IP address reachable over the WAN (1030) and may be interconnected in a virtual private network by virtual tunnel connections (1060a), (1060b) and (1060c). Additionally all three servers (1035), (1040) and (1045) may comprise virtual servers operating within the same physical device or some or all the servers (1035), (1040) and (1045) may comprise a plurality distributed devices operating remotely from each other without deviating from the present invention.

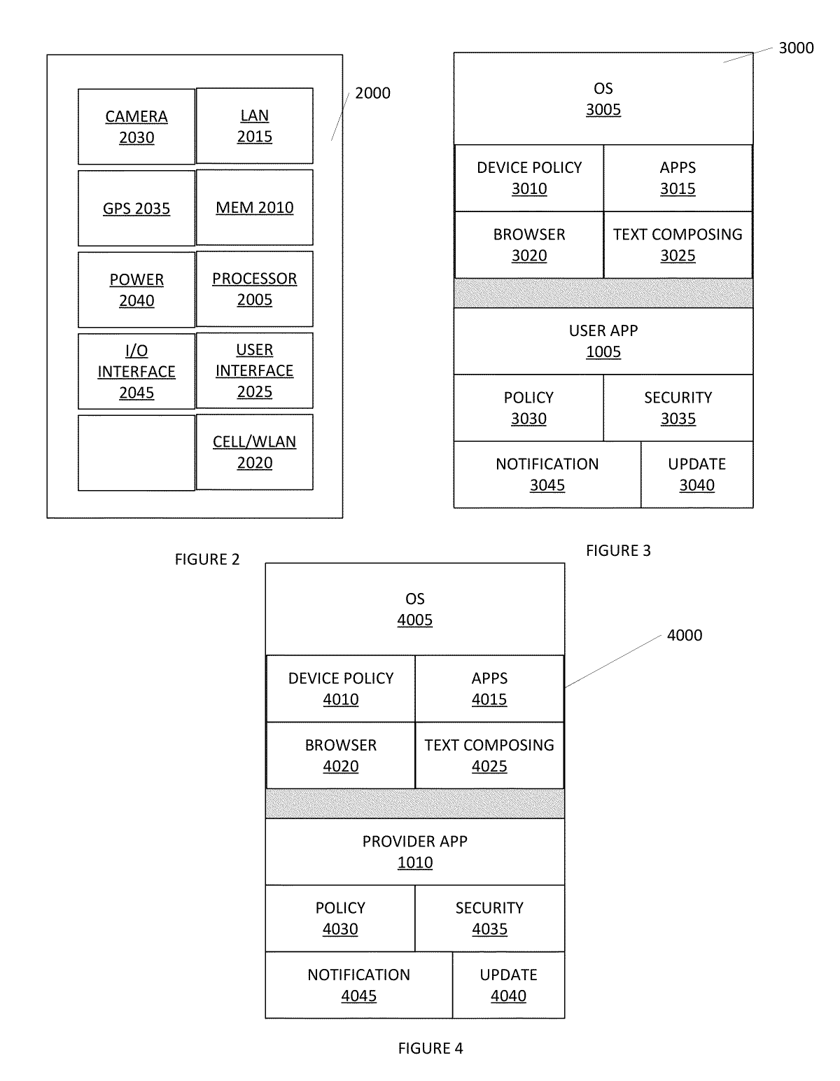

Turning now to FIG. 2 a block diagram depicting non-limiting exemplary telecommunications device (2000) usable as a user front-end device (1015) or usable as a provider front end-device (1020). The telecommunication device (2000) includes a digital data processing device (2005) such as a programmable logic device, or the like, in communication with a memory module (2010). The memory module (2010) stores digital data and various device operating instruction sets or drivers as may be required to operate the telecommunication device (2000). The device operating instruction sets operate on the data processing device (2005) or cooperate with the data processing device (2005) to operate the telecommunication device (2000). Other software, firmware or digital instruction sets, generally applications, that are separate from device operating instruction sets or device drivers may be provided on or added to the memory module (2010) for operation on or in cooperation with the data processing device (2005). Application examples include but are not limited to an internet browser, an email application, a texting or messaging application, a contact list application, or the like.

The telecommunication device (2000) includes one or more wired network interface devices (2015) and or one or more wireless network interface devices (WLAN) (2020), or both, in communication with the digital data processing device (2005). Each wire network interface device (2015) and wireless network interface device (2020) is operable to communicate with remote telecommunication devices connected to a wire or wireless network. Generally each wire network interface device (2015) and wireless network interface device (2020) connects to a particular network type and communicates with remote telecommunication devices connected to the particular network type using a compatible network signal configuration and communication protocol.

The telecommunication device (2000) includes a user interface (2025) in communication with the digital processor (2005). Typically the user interface (2025) includes a screen display, or other visual indicator elements, a key pad, or other tactile input elements, an audio speaker, a microphone, or the like. The telecommunication device (2000) includes a power module (2040) such as a rechargeable battery and power management elements and various wire input/output interfaces (2045) suitable to interface with outer devices by a wire connector. The telecommunications device (2000) optionally but preferably includes a still and or video image recorder or camera module (2030) operable to record and store images and store the images on the memory module (2010) or transmit the images over a network, and a global position system (GPS) (2035) operable to track a global position of the telecommunication device (2000) and store the global position history on the memory module (2010) or periodically transmit the global position of the telecommunications device (2000) to another device over a network.

Turning now to FIG. 3 a block diagram depicting non-limiting exemplary system architecture (3000) usable with the telecommunications device (2000) shown in FIG. 2. The system architecture (3000) includes a device operating system (OS) (3005). The device OS (3005) may comprise a standard smart phone or tablet operating system such the iOS® mobile operating system operable on smart phones and other telecommunication devices (2000) available from Apple Inc. or the Android® mobile OS developed by Google Inc., which is operable on numerous other telecommunication devices (2000). Other non-limiting exemplary device OS (3005) include the Windows® OS sold by Microsoft Inc. or the Mac OS X® sold by Apple Inc. as well as the UNIX® OS conforming to The Open Group Base Specification, Issue 7 and or a LINIX® OS maintained by the LINUX FOUNDATION, or the like.

The device OS (3005) manages resources of the telecommunication device (2015) such as distributing power from and receiving power into the power module (2040), managing data storage on the memory (2010), applying device security and policy rules to controlling elements of the user interface (2025) or the like. The device OS (3005) includes a device policy manager (3010), operable to manage device policies and security and further operable to display a settings menu, or the like, usable to change device policy and security settings. The device OS (3005) interfaces with optional hardware devices such as the camera module (2030), GPS (2035), or the like, to integrate camera and image storage and integrate geographic location tracking with other functions of the telecommunication device (2000).

The device OS (3005) interfaces with network interface devices (2015) and (2020) in order to manage network interface activities including formatting and routing outgoing network traffic, receiving, formatting and distributing incoming network traffic to appropriate applications, or the like, managing software updates and version control, maintaining activity logs, and other routine device specific tasks.

A plurality of non-operating system software applications or APP's (3015) is operable on the telecommunication device (2000). APP's (3015) may include but are not limited to an internet browser application (3020), various text composing and editing applications (3025), such as text messaging, internet messaging, email messaging, work processing, or the like, that also include elements for maintaining a contact list, an appointment calendar, or the like. Other APP's (3015) may include special purpose applications e.g. YELP for finding local business, e.g. Google Maps for displaying maps and providing driving directions and numerous others APP's (3105).

As shown in FIG. 3, the user front-end application (1005) is installed on the telecommunications device (2000). The user front-end application (1005) includes an AFMS policy manager (3030), a security manager (3035), an update manager (3040) and a notification manager (3045) operating on the telecommunications device (2000). All of the manger modules (3030), (3035), (3040) and (3045) are installed with the user front-end application (1005). Any of the manager modules (3030), (3035), (3040) and (3045) can be modified by data exchanges with the user application server (1040) e.g. by the update module (3040). The AFMS policy manager (3030) operates in cooperation with the device OS (3000) to allocate device resources to the user front-end application (1005) and may operate to install appropriate software drivers and other software modules on the telecommunications device (2000), e.g. the notifications module (3045) after determining characteristics of the telecommunications device (2000).

The security manager (2035) controls access to user front-end application (1005) by preventing the user front-end application (1005) from operating without appropriate user log in information. The security manager (3025) is operable to manage a plurality of different users with different user ID's. The security manager (2035) can allow access to users that have user ID's stored on the telecommunication device (2000). Otherwise, the security manager (2035) can interact with the user application server (1040) to determine if an unknown user ID is associated with a valid user and if so provide the valid user with access to the user front-end application (1005) if the user privileges allow it. Additionally the security manager may limit access to specific providers, to specific services or the like.

The update manager (3040) manages activity logs and program versions stored by the user front-end application (1005) and periodically upload the activity logs to the user application server (1045) and may periodically download updated program versions to the telecommunications device (2000).

The notifications manager (3045) manages user notifications and user responses to the user notifications. Generally user notifications include messages or other graphic information displayed for the user on a video display device operating on the telecommunications device (2000). Alternately user notifications include audio messages including telephone voice messages played on audio speakers operating on the telecommunications device (2000). Additionally user notifications can be communicated to the telecommunications device (2000) as an email, a text message, an internet message, a web browser page or other message from that can reach the telecommunications device (2000) from the user application server (1040) or other elements of the AFMS (1000).

Turning now to FIG. 4 a block diagram depicting non-limiting exemplary system architecture (4000) usable with the telecommunications device (2000) shown in FIG. 2. In the particular embodiment shown in FIG. 4 the system architecture is configured as a provider front-end device (1020) operating the provider front-end application (1010). The system architecture (4000) includes a device operating system (OS) (4005). The device OS (4005) may comprise a standard smart phone or tablet operating system such the iOS® mobile operating system operable on smart phones and other telecommunication devices (2000) available from Apple Inc.; or, the device OS (4005) may comprise the Android® mobile OS developed by Google Inc., which is operable on numerous other telecommunication devices (2000). Other non-limiting exemplary device OS's (4005) include the Windows® OS sold by Microsoft Inc. or the Mac OS X® sold by Apple Inc. as well as the UNIX® OS conforming to The Open Group Base Specification, Issue 7 and or a LINIX® OS maintained by the LINUX FOUNDATION, or the like.

The device OS (4005) manages resources of the telecommunication device (2000) such as distributing power from and receiving power into the power module (2040), managing data storage on the memory (2010), applying device security and policy rules to controlling elements of the user interface (2025) or the like. The device OS (4005) includes a device policy manager (4010), operable to manage device policies and security and further operable to display a settings menu, or the like, usable to change device policy and security settings. The device OS (4005) interfaces with optional hardware devices such as a camera module (2030), a GPS module (2035), or the like, to integrate camera and image storage and geographic location tracking with other functions of the system architecture (4000).

The device OS (4005) interfaces with network interface devices (2015) and (2020) in order to manage network interface activities including formatting and routing outgoing network traffic, receiving, formatting and distributing incoming network traffic to appropriate applications operating on the system architecture (4000). The device OS (4005) also managing software updates and version control, maintains activity logs, and performs other routine device specific tasks.

A plurality of non-operating system software applications or APP's (4015) is operable on the system architecture (4000). APP's (4015) may include but are not limited to an internet browser application (4020), various text composing and editing applications (4025), such as text messaging, internet messaging, email messaging, word processing, or the like, and the APP's (4015) may also provide contact list management, a calendar and appointment manager, or the like. Other APP's (4015) may include special purpose goods and service provider applications such as a spread sheet application e.g. Microsoft Excel, a database application or interface to a database wherein the database list a goods and services inventory, a pricing table, and the like, as well as other applications applicable to managing goods and services offered by the service provider.

The provider front-end application (1010) is installed on the telecommunications device (2000). The provider front-end application (1010) includes an AFMS policy manager (4030), an AFMS security manager (4035), an AFMS update manager (4040) and an AFMS notification manager (4045) operating on the system architecture (4000). All of the AFMS manger modules (4030), (4035), (4040) and (4045) are installed with the provider front-end application (1010). Any of the AFMS manager modules (4030), (4035), (4040) and (4045) can be modified by data exchanges with the provider application server (1045) e.g. by the AFMS update module (4040). The AFMS policy manager (4030) operates in cooperation with the device OS (4000) to allocate device resources to the provider front-end application (1010) and may operate to install appropriate software drivers and other software modules on the telecommunications device (2000), e.g. the notifications module (4045) after determining characteristics of the telecommunications device (2000) and the system architecture (4000).

The AFMS policy manager (4030) used for service provider operators may assign different operator privileges to various goods and services operator types such as an operator privilege, a manager privilege and administrator or other level of use privilege. In one specific example, an operator having an operator level privilege can generate or approve sending a pre-composed message to a user or customer, but not generate or approve sending a customized message or offer. However with a higher access privilege, e.g. a manager privilege, the manager may be allowed to compose an original user notification, submit an offer to the user wherein the offer includes a price discount, an upgrade, complementary goods or services or other compensation. Additionally certain requests are preconfigured to generate a provider workflow to address issues identified by a user. In one non-limiting example the provider application server or on the provider front-end application is operable to establish a workflow and send message to various staff members to take actions to correct a problem. Additionally the networked application can track the workflow to completion and report back to the user.

The AFMS security manager (4035) controls access to provider front-end application (1010) by preventing the provider front-end application (1010) from being accessed without appropriate log in credentials. The security manager (4025) is operable to manage a plurality of different operator ID's associated with a plurality of different service provider operators. The security manager (4035) can interact with the provider application server (1045) to determine if an unknown operator ID is associated with a valid operator and if so provide the operator with access to the provider front-end application (1010).

The AFMS update manager (4040) manages activity logs and program versions stored by the provider front-end application (1010) and periodically will upload the activity logs to the provider application server (1045). The AFMS update manager (4040) manages downloads from the provider application server (1045) which may include updated program versions of the provider front-end application (1010) updated user information, updated provider information and other information usable by the user and or the provider front-end application (1010).

The provider notifications manager (4045) presents user notifications and user responses to a provider operator. Usually the user notifications are pre-composed notification selected by a message selection algorithm according to situational information. A provider operator can review each user notification on the provider message notifications manager (4045) and choose to approve the user notification, select a different pre-composed user notification or cancel the user notification. In some instances the provider operator can modify a pre-composed user notification, compose a new user notification or submit an offer to the user. An offer may include a price discount, an upgrade, complementary goods or services or other compensation.

User notifications generated by the provider notification manager (4045) are sent to provider application server (1045) for delivery to the user through the user application server (1040). Usually the user notifications are graphic information displayed for the user on a video display device operating on the telecommunications device (2000) using the system architecture (4000). Alternately user notifications can include audio messages such as an automated voice announcement or telephone voice message playable by the user on an audio speaker operating on the telecommunications device (2000). Additionally user notifications can be communicated to the telecommunications device (2000) as an email, a Short Message Service (SMS) text message, an internet message, a web browser page or other message format that can be received by the telecommunications device (2000) and communicated to the user.

The user front-end application (1005) can be instantiated on the telecommunications device (2000) by a download from the user application server (1040) or other WAN servers. The provider front-end application (1010) can be instantiated on the telecommunications device (2000) by a download from the provider application server (1045) or other WAN servers. Either of the user front-end application (1005) and/or the provider front-end application (1010) can be instantiated on the telecommunications device (2000) by a data transfer from a removable memory device, disk drive or other computer device telecommunications device or the like, e.g. a through a Unified Serial Ports (USB) or serial or parallel communication channel. In various non-limiting example embodiments the user front-end application (1005) and the provider front-end application (1010) can be a plug-in or extension to the device OS (3005) or (4005). Example telecommunication devices (2000) include a portable or hand-held device such as smart phone, a personal digital assistant, a tablet computer, a lap-top computer, or any other portable or hand held telecommunications device. Generally user front end devices (1015) that are owned by a user are preferably portable devices such as a smart phone or tablet computer that include a cellular network interface device that gains access to the WAN (1030) over a cellular network gateway to the WAN. Example non-portable telecommunication devices (2000) include non-portable or desk-top computers or terminals such as a point of sale device or other data entry terminals. Generally provider front end devices (1020) are non-portable devices located in a back office or at a point of sale location, however, provider front end devices (1020) can be implemented on portable devices such as smart phones and tablet computers. Typically these devices include a LAN or WLAN network interface devices that gains access to the WAN (1030) over a LAN or WLAN using an internet service provider gateway to the WAN.

Some providers may place non-portable kiosk user devices at the provider cites for use by any user or customer that visits the provider site. Typically the user interacts with the provider of goods and services by operating the kiosk. The kiosk may be located at a provider site, e.g. a bank Automatic Teller Machine (ATM) or the kiosk may be a provider site, e.g. a Redbox movie rental kiosk or the like. Kiosk transactions may include but are not limited to identifying the user, e.g. when the user is prompted to enter a user ID or to personal information. Kiosk transactions may include purchasing goods and services, paying for goods and services, changing or cancelling an order, returning goods and services, checking into or checking out of an event, provider site or virtual service, making or cancelling a reservation or the like.

A point of sale device is usable as a provider front-end device (1020). Typically the point of sale device is operated by a provider operator to record purchases and collects payment. Point or sale transactions may include recording a sale or order, recording a return or cancellation, recording a user check-in or check-out, recording a user reservation or cancelation, or the like.

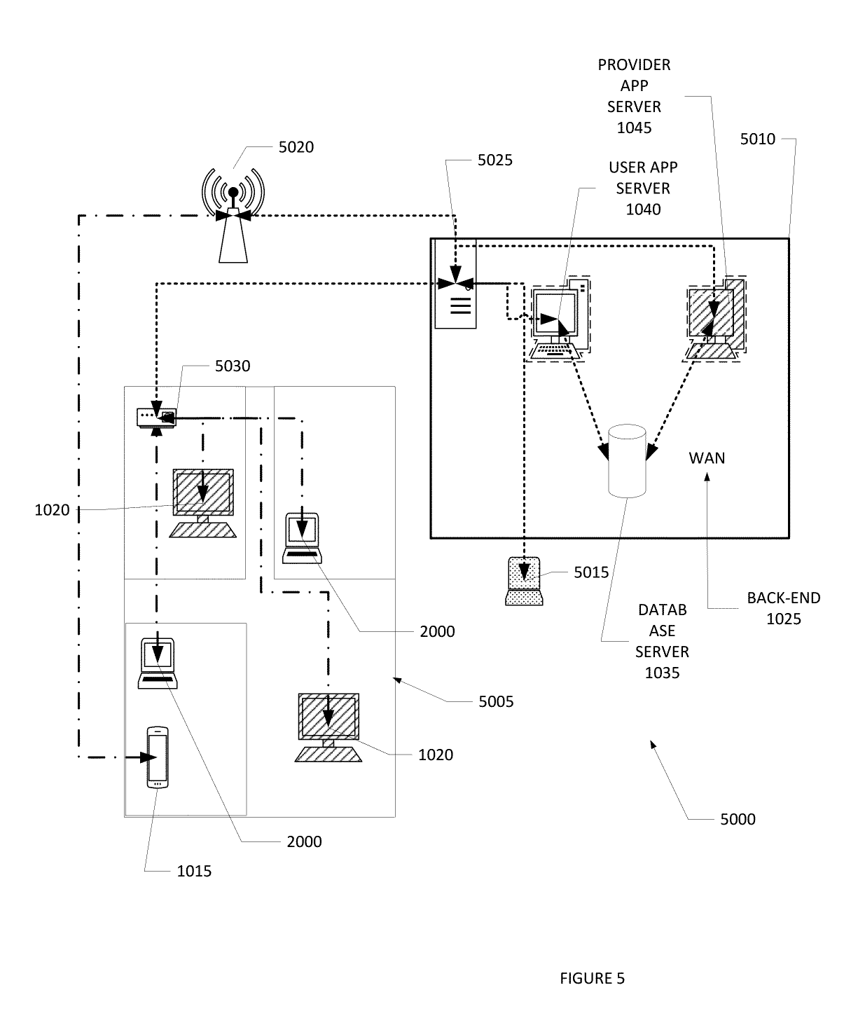

Referring now to FIG. 5 a block diagram depicts a non-limiting exemplary Active Feedback Management System AFMS operating environment (5000) according to the present invention. In the present example operating environment a single user or customer is located at a provider site (5005). The provider site (5005) is operated by a provider of goods and services to sell and or provide goods and service to the user. An Active Feedback Management System Operator, (AFMS operator) provides and actively maintains an AFMS, described above. The AFMS includes the user front-end application (1005) operating on a telecommunication device (2000) that can be used by the user to access services of the AFMS, the provider front-end application (1010) operating on a telecommunication device (2000) that can be used by the provider to access services of the AFMS, and a networked back-end system operating on a wide area network (WAN) (5010). The networked back-end system at least includes a user application server (1040), a provider application server (1045) and a data-base server (1035). In addition the networked back-end includes various interface terminals (5015) usable by the AFMS operator to manage and interact with the networked back-end system.

In the present example operating environment (5000), the user is located within the provider site (5005). The user is carrying a user front-end device (1015), such as a personal smart phone or tablet computer or custom hardware, and the user front-end application (1005) is installed on and operating on the user front-end device (1015). The user front-end device (1015) is a client of a cellular network through a local cellular access point or cell tower (5020). The cellular access point (5020) is in communication with a WAN gateway (5025) which allows the user front-end application (1005) operating on the user front-end device (1015) to communicate with the user application server (1045).

In one non-limiting exemplary operating mode, the user front-end application (1005) periodically transmits a geo-location of the user front-end device (1015) to the user application server (5020). In response to receiving the user geo-location information the networked back-end system operates to determine if the current user located is associated with a provider site (50050 supported by the AFMS and if so the networked back-end system operates to determine if the current user subscribes to the AFMS services for that particular provider of goods and services. Then if the provider is supported and the user is supported and the user is at a supported provider site, the AFMS operates to perform one or more services which include sending messages to the user, the provider or both.

A user message that may be sent to the user is a welcome message. In various examples, the welcome message may address the user by name and welcome the user back to the provider site if the user has been there before. Optional welcome message content may include listing the date of the last user visit, confirming that the user has an appointment or was expected, or other content that is personal or situational in view of the known circumstances. In the present example, the known circumstances may include user information and provider information. Some user information may be stored on the user front-end device (1015) e.g. a user ID and the user location. Other user information is stored on the user application server (1045) and/or on the database server (1035). In one non-limiting example, the user application server (1045) and/or on the database server (1035) may retrieve a user profile including user name and home address, user age, sex, marital status, user shopping history at the proprietor site (5005), user shopping history at all proprietor sites and the like. Based on the user profile, the user application server (1045) and/or on the database server (1035) may identify certain triggering information that may generate a separate user message or influence the content of the user greeting message. Triggering information details that can influence message content may be to recognize that the user is traveling far from home that today is the user's birthday, that the user has a reservation or appointment, that the user has made a recent purchase, or the like.

In the present example operating environment (5000), the provider site (5005) is connected to the WAN gateway (5025) by a modem or router (5030). Inside the provider site (5005) the provider operates one or more provider front-end devices (1020), shown with hashed lines. Each provider front-end device (1020) interfaces with the modem or router (5030) as a network client of a LAN or a WLAN or both. Thus each provider front-end devices (1020) and the provider front-end application (1010) operating on the provider front-end devices (1020) is in communication with the provider application server (1045) over the modem or router (5030), the WAN gateway (5025) and the WAN (5010). In an example embodiment some provider front-end devices (1020) are point of sale devices user to record purchases and other transactions such as check-ins, check-outs or the like. Meanwhile other provider front-end devices (1020) are back office terminals wherein the back-office terminal operator does not have contact with the user (customer).

After recognizing that the user is at the provider site (5005) the networked back-end system (1025) operates to determine if any of the provider front-end devices (1020) located at the provider site (5005) have records stored thereon that indicate that the user has already interacted with a provider staff or system at the provider site (5005). If not, the networked back-end system (1025) may operate to send a provider message to one or more provider front-end devices (1020) located at the provider site (5005). In addition, the networked back-end system (1025) operates to compile a user profile, described above, and present the user profile to or make the user profile available to one or more provider front-end devices (1020) located at the provider site (5005).

The provider site (5005) may include one or more additional telecommunications devices (2000). Each additional telecommunications device (2000) interfaces with the modem or router (5030) as a network client of a LAN or a WLAN or both. Thus each additional telecommunications device (2000) is in communication with any one of the networked back-end systems over the modem or router (5030), the WAN gateway (5025) and the WAN (5010). Each additional telecommunications device (2000) may operate the user front-end application (1005) such that the additional telecommunication devices (2000) are usable by any user to gain access to the AFMS with appropriate user log in credentials. Similarly each additional telecommunications device (2000) may operate the provider front-end application (1010) such that the additional telecommunications devices (2000) are usable by any provider staff to gain access to the AFMS as a provider. The additional telecommunications devices (2000) may also operate other applications such as a web browser, and or portal interfaces that allow a user or a service provider staff member to view provider goods and services order goods and services from the provider, enter user personal information, make payments or select a payment type, or the like. In one embodiment at least one of the additional telecommunications devices (2000) is a kiosk. In one embodiment at least one of the additional telecommunications devices (2000) is a point of sale device.

Still referring to FIG. 5, the AFMS operator provides AFMS services to goods and service providers that wish to obtain more meaningful feedback from customer or user of their goods and services. In order to provide the AFMS services the AFMS operator populates the database server (1035) with information relating to the goods and services provided such as provider site locations, operating hours, goods and services provided, pricing information and other information such as building amenities, building layout, building conditions, parking structure, nearby amenities and transportation and the like. In addition the AFMS operator determines specific feedback needs of the goods and service provider. While some feedback needs may be specific such which customers or how many customers actually view a particular customer message, some feedback needs are more subtle such as how can we sell more wine on Thursdays.

In one example operating mode the provider and the AFMS operator generate a plurality of pre-composed user messages. Each pre-composed user message may be non-user specific but situational specific. In one example a customer checks into a hotel room. The check-in event is recorded on a provider front end device (1020). The provider front end device (1020) reports the checking event to the provider application server (1045). The provider application server (1045) first determines is the customer is a user of the AFMS. The provider application server (1045) pulls customer records from the database server (1035) and updates the database server to record that the customer, has checked in to a particular room at a particular provider site at a particular local time and was greeted by a particular provider staff member. If the customer is a user of the AFMS the provider application server (1020) may select a pre-composed user message to submit to the user. If so pre-composed user message is presented to the user application server (1045) and then presented to the users' own user front-end device (1015). If the user front-end device is not responsive or if the customer is not a registered user, the pre-composed user message may be sent to the user's room at the hotel for display on a telecommunications device (2000) that is located in the users' hotel room.

The pre-composed user message may be situational but user generic, e.g. the pre-composed user message may merely welcome the user to Hotel X and acknowledge that the user has checked in. In some cases the pre-composed user message may be modified to include more situational information such as the automatically edited user message may welcome the user to Hotel X and acknowledge that the user has checked in to room Y and that the user has requested a 3 night stay.

In other operating modes the provider application server (1045) may select a pre-composed request for feedback to submit to the user. The pre-composed request of feedback may be situational but user generic, e.g. the question may be during your check-in did a staff member escort you to your room?

Thus according to the present invention pre-composed user messages and pre-composed user request for feedback are stored on the provider application server (1045) and submitted to users in automated fashion by triggering events. In particular a triggering event is situational such as a customer has just checked in to a hotel room and the pre-composed user messages and pre-composed user request for feedback are specifically related to the situation. In example embodiments the situational message may include details of the provider site, e.g. providing parking information, a list or restaurants and locations or the like. In example embodiments the situational message may include details of the user e.g. number of people in the user's party or user preferences e.g. non-smoking room or the like. Other situational message may include adjusting a wake-up call the correct to local time or providing airport shuttle information to multiple local airports. A situational event can be recurring, e.g. deliver coffee vey morning or the like.

In a further operating mode a provider staff member may notice that a triggering event has occurred or is about to occur and the provider staff member may select one or more pre-composed user messages and pre-composed user request for feedback from a menu of messages and request for feedback presented to the provider staff member by the provider front end application (1010). In a still further operating mode a provider staff member my compose a new message or request for feedback for submission to one or more customers or users. In further embodiments a group of users may be affiliated, e.g. all in the same family, or all attending the same event, or all affiliated with the same organization and pre-composed user messages and pre-composed user requests for feedback may be sent to the entire user group at once.

In cases where the user participating in a user session expresses some dissatisfaction with some aspect of the goods and services being provided a provider staff member may take certain actions to address the user's dissatisfaction. In one example embodiment the provider staff member may attempt to fix the problem, e.g. when asked if the room cleanliness was satisfactory the user answered NO. In response to the NO answer the provider staff member may instruct the cleaning staff to go to the room and clean it, or the like. In addition as compensation of the unfavorable response the provider staff member may make a compensation offer to the user. The compensation offer may include offering a room upgrade, or a discount on the room price, or offering the user free parking or a complementary drink or meal at the hotel restaurant.

As with messaging and requests for feedback, offers may be generated based on a situational triggering event which is usually some form of customer dissatisfaction. In one example an unfavorable user response to a request for feedback may generate a pre-composed user message to submit to the user. Additionally the same triggering event may generate an automatic message to a provider staff member to clean the room or otherwise solve the customer dissatisfaction. In addition a pre-composed compensation offer may be sent to the user. Thus according to the present invention the provider application server (1045) is operable to automatically manage unfavorable user responses to a request for feedback and may select an appropriate situational action to be performed by a provider staff member and may alert the provider staff member by selecting a pre-composed message instructing the provider staff member what needs to be done. Moreover the provider application server (1045) is operable to automatically manage compensation offers to unsatisfied users. However in each scenario a provider staff member may intervene to either approve or alter the customer message, the solution to solve the customer dissatisfaction and the compensation offer. The present invention is usable in various environments where users (Consumers) of goods and service interact with goods and service providers such as hotels, restaurants, airlines, automobile rental agencies, grocery stores, mercantile stores, hardware stores, hospitals, universities and so forth. In some operating modes the AFMS system (5000) is operable to generate personal and or situational messages for deliver to the user. In some operating modes the AFMS system (5000) is operable to generate personal and situational request for feedback. In some operating modes the AFMS system (5000) is operable to generate personal and or situational messages for deliver to the user to address a user's dissatisfaction. In some operating modes the AFMS system (5000) is operable to instruct provider staff members to address the needs of the user. In some operating modes the AFMS system (5000) is operable to make compensation offers to the user.

A benefit of the present invention is the ability to get very specific user feedback about specific product or service offerings. A further benefit of the present invention is the ability to understand factors that damage or improve customer brand loyalty and reduce liabilities. Matching accurate feedback and demographic information with location-based sensing devices that can transmit said information to service providers in real-time provides for increased responsiveness to said feedback.

For purposes of this application, a web or mobile browser applications may refer to a software application or display produced by steps performed by processing circuitry for retrieving, presenting, interpreting, and traversing information resources provided by a remote server (e.g., on the internet). At the time of this application, web/mobile browsers may include Chrome, Firefox, Internet Explorer, Opera, and Safari. In addition, a web/mobile application also referred to as an application or “app” as described herein includes computer software designed to help the user to perform specific tasks on a computer or using a mobile device. The application functions are performed by processing circuitry, such as a computer, mobile device, or server, as further described herein. For purposes of the systems and methods described herein, a plug-in may refer to a set of software components that adds specific abilities to a larger software application, such as a web browser or native mobile application. Plug-ins enable customizing the functionality of an application and may be implemented in any suitable architecture, such as Apple iOS, Google Android, Microsoft Windows, Flash player, Java applet, HTML5, or any other commonly used platform known in the art. For purposes of method, a plug-in is a general term which could also be synonymously associated with add-ons, snap-ins, and extensions.

In one embodiment, when activated, the processing circuitry of the user front-end device (1015) determines the location of a user, determines if a service provider using the active feedback management system is in the vicinity and prompts the user with a message. For example, a user carrying a smartphone device enters into a restaurant identified as a service provider supported by the AFMS system (5000). The system (5000) generates a pre-composed message to display on the user front-end device (10150 to say, “Welcome to the Restaurant” and “we noticed you are a returning customer, in appreciation for your business please present this message to your server for a 15% discount.”

Other examples message delivery formats include the portal processing circuitry or user processing circuitry to notify the user by email, a notification at a user portal, a text message, a cellular telephone system, and/or a social media site (Twitter, Facebook, etc.). In additional embodiments, the communication between the processing circuitry related to the location and service provider may provide discounts, special events, welcoming messages, upgrades, personalized surveys, and so forth.

In some embodiments, aggregate information may be shared on the social sites, review sites, and/or provider own portal or website.

In some embodiments, the user controls the type and/or amount of information service provider's and vendors obtain. For example, the user inputs certain demographic information in their user profile including: marital status, gender, race, age, weight, residence, education levels and so forth. The user may choose which of these bits of information the specific service provider may have access to whether that information is associated with a username, sent anonymously or not at all. Additionally, the user may control the amount and type of tracking information such as location, history of visits or check-ins to hotels, restaurants, airlines, stores, and so forth to be acquired anonymously, associated with the username, not at all.

The user may even choose to let certain service providers have access to their entire history of a type of business, such as hotels that the user has visited in attempt for the business to bid for their business. For example, user ‘Bob’ stays 45 nights a year at hotels. Bob stays at Hotel A 25 nights, Hotel B, 15 nights and other hotels the other nights. If Bob allows Hotel A to see the user history, Hotel A may notice that 8 of the 15nights Bob stayed at Hotel B there was a nearby Hotel A and may offer discounts for the next time Bob is in that area to stay at Hotel A instead of Hotel B. Alternatively, Hotel A may see that their particular hotel is always booked in that area and determine customers like Bob my actually choose to stay at another Hotel A if there was another Hotel A or more capacity.

In some embodiments, by having control over usage information, users now have the ability to be in control of who they choose to compete for their business. Usage information may be stored in a database associated with the user profile such as on a server, in the cloud, or even on a local database or memory storage.

### Individualization:

When a user (customer, business partner or associate) arrives on a business premise (for e.g.: hotel, restaurant, hospitals, retail, etc.), the user front-end application (1005) operating on the user front-end device (1015) tracks the arrivals and informs the business of the users' presence. Business can use the information to provide better individualized service to the user. In this example this is the start of a user session.

### Activity Tracking:

During the entire user session, the AFMS (5000) continuously monitors user's consumption of business services and products, (consumer products) until the user departs from the business premise at the end of a user session. The provider front-end application (1010) can also alert the system of the customer's presence or the user can manually declare the intent by entering the start of the user session into the user front-end application, (1005). As the user utilizes specific service(s) of the business, various user encounters or triggers, may automatically generate user messages, user request for feedback and or staff responses to user dissatisfaction include fixing the problem and making compensation offers.

### Context Feedback:

For single instance Consumer Product (Razor), User can scan the product barcode or payment receipt or unique resource code using phone camera or the like to trigger the user session. Based on a messaging algorithm that matches situational and or user information with appropriate feedback specific pre-composed questions are sent to the user front-end application and or the provider front-end application to capture user responses as they relate to the specific consumer product. A metadata of all the available product unique code (barcode, QAR) is stored in back end (1025). Product may also generate custom unique code from the system. If the feedback associated with the product includes some kind of failure the system may also quickly determine to send a follow-up prompt to take a photo, send additional information, or request a customer service representative call them or engage with them electronically through texting or online chatting.

For groups of products and services e.g. hotels, a user utilizes different services which can be differentiated by custom QAR Codes or product barcodes or the like. The QAR Codes are recorded, analyzed, and related questions are selected and transmitted by the AFNS (5000). Each session and encounter detail may be captured by user unique QARs for individual content receipts or other data capturing mechanism from the business. User feedback data can be shared with specific business website, social networks, and other user generated content system.

### Action Mechanism:

User feedback is captured and sent to the user application server (1045) on the networked back-end and then to the provider application server to be transmitted to members of a business service team for review in real time. The business service team may take action to improve the user experience. User session ends after the completion of one or more user transactions. In some instances, user has not left the provider site (5005) and service team can present the user with actions which improves user experience with the overall service. In other instances, user has left the provider site (5005), the service team can use the user front-end application (10050 or other contact mechanism (Phone, Email, SMS) to provide actions to potentially improve user satisfaction. In a further operating mode of the AFMS (5000) one-time instance and temporal user feedback data will be combined with other forms of Meta data and will be used to provide intelligence analysis for positively improving the user experience in particular situations where user feedback is collected. This provides business a holistic view of the user profile.

### EXAMPLE:

a) A user arrives at a provider site (5005).

b) The user front-end application (1005) detects user location or the provider front-end application (1010) reports a transaction that involves the user.
The networked back-end (1025) checks to determine if the provider site (5005) is a supported business location,
if so the user front-end application (1005) alerts the provider front-end application (1010) that the user has arrived, the information is exchanged between the user application server (1045) and the provider application server (1045);
The networked back-end (1025) assembles user demographics shopping history etc. (user transaction history)

c) User App server (1040) records the start of a user session (everything that happens during the visit) and records a first specific encounter as an arrival.

d) Provider App server (1045) selects pre-composed situational and or user specific questions for delivery to the user over the user front end application (1005).

e) A provider staff member or business management team may review, approve, modify or disapprove the pre-composed situational and or user specific questions

f) Provider application server (1045) may select pre-composed compensation offers user recommendations and or requests for feedback, to collect additional feedback from the user.

User recommendations and offers are based not only on user person information but also on user demographic e.g. based on what they are watching on TV or other actions (web browser).
The content specific questions may further include user specific details based on prior encounters with the user or other user records.
The content specific questions may be communicated directly to the user on the user front-end device (1015) or on a telecommunications device (2000) provided at the service site (5005) such as a computer, smart phone, television set top box, kiosk or the like.

g) User gives input/feedback

h) Other service encounter are monitor and user feedback is requested for more feedback

i) User leaves (end of user session triggers request for final feedback)

j) User finalizes feedback sends rating

k) AFMS (5000) generate a report for delivery to the service provider and stored the report and the survey results in the database server (1035).

### Use Cases:

### Individualization and Related Feedback

### Hospitality

Feedback: As a user uses different services in the hotel (pool, gym, lobby, and restaurant) a telecommunication device (2000) is used to keep track of user interaction. For example the telecommunication device (2000) may comprise a kiosk agent or service agent that is response to user key entries or the like e.g. to the pool, gym, parking garage, elevator or the like. Based on the usages, a user specific or situational question is sent to a user front-end application (1005). Alternately other user communication pathways are usable such as SMS, website, email and Voice.

### Individualized Recommendation:

As user utilizes the system & history of the activities are analyzed in relation to other similar members. System will generate recommendation and/or the service provider can create their own list of recommendation, which can be personalized to user preference and delivered to user phone e.g. recommendations for Food, Drinks, promotion, Health club, Pool, etc.

### Relevant Information:

As User moves from one provider site (5005) to another provider site (5005) or interacts with a plurality of different service providers using different goods and services which are recorded in the database server (1035), the data may be aggregated with other metadata (home location, work profile, shopping history) and combined to provide intelligence about the user which can be used to improve user experience. For e.g. other hotel stays Food preferences, Pub/wine bar/Jazz bar, etc.

### Restaurants/Coffee Shop

Individualized Service: As user arrives on a provider site (5005), the AFMS system (5000) may operate to alert service provider staff, via the service provider front-end application (1010) of the users' preferences, e.g. seat, wine, food, etc. As a user is served drinks, food, service, ambience, etc. user specific or situational questions are sent to the user front-end application (1005) and user feedback is captured. The service encounter can be proactive trigger by user by scanning a specific code, by restaurant service team by manually entering/scanning the order.

### Retail

### Product

### Barcode (**):

As user arrives on a provider site (5005), the AFMS system (5000) may operate to alert service provider staff, via the service provider front-end application (1010) with user preferences (Past shopping history, etc.), as a user walks around the different sections, user can either scan the product barcode to give proactive feedback regarding specific product/services. Each product barcode is tied to a questionnaire in the system. The feedback on individual product may be shared with social network sites and/or product

### Healthcare

Non direct location data: As insurance uses claim data, to identify the service which was utilized by the user, a personalized questionnaire is sent to user front-end device (1015) to capture the feedback. A doctor, service provider staff, treats a patient, user. The doctor recommends follow up questions to ask the patient the next day, e.g. do you have more or less swelling than yesterday? Do you have more or less pain than yesterday etc.? Alternately the follow up questions may comprise pre-composed questions that are automatically selected and sent to the user by the system (5000).

1. A networked application system comprising:
a plurality of user front-end devices each operating a user front-end application;
a plurality of provider front-end devices each operating a provider front-end application;
a networked back-end operable to interface with the user front-end application of each of the plurality of user front-end devices and with the provider front-end application of each of the plurality of provider devices;
wherein a user of the user front-end application is uniquely identified by a user ID;
wherein each provider front-end device is uniquely associated with a provider of goods and services and with a provider site;
wherein the networked back-end is operable to monitor each of the plurality of user front-end devices, and each of the plurality of provider front-end devices to detect a triggering event comprising an interaction between the user and a provider site.

2. The networked application of claim 1 wherein the triggering event is detected when the networked application determines that a user having a known user ID is operating a user front-end device located at the provider site.

3. The networked application of claim 1:
wherein the networked back-end stores a geo-location of each provider site;
wherein any one of the plurality of user front-end devices is equipped with a global positioning system (GPS) device;
wherein the user front-end application is operable to read a geo-location the GPS device and to transmit the geo-location to the networked back-end; and, wherein the networked back-end operates to compare the geo-location of user front-end devices with the geo-location of provider cites and to detect a triggering event when a geo-location of a user front-end device is matched to a geo-location of a provider site.

4. The networked application of claim 1 wherein a triggering event is detected when any user having a known user ID is involved in a transaction recorded on any provider front-end device operating the provider front-end application.

5. The networked application of claim 4 wherein the transaction recorded on any provider front-end device includes user data comprising any one of a user name, a user payment method record, a user address, a user email address, a user telephone number, and the networked application is operable to match the user data with a user ID.

6. The networked application of claim 5 wherein the provider front-end device comprises a point of sale device.

7. The networked application of claim 1:
wherein the networked application includes a plurality pre-defined triggering event type definitions stored thereon;
wherein the networked application includes a plurality of pre-defined responses to triggering events stored thereon;
wherein for each triggering event the networked application operates to determine which triggering event type to associate the triggering event with.

8. The networked application of claim 7 wherein in response to each triggering event the networked application reacts with a response comprising any one of:
sending a message to the user front-end device associated with the triggering event;
sending a message to one or more provider front-end devices associated with the provider site associated with the triggering event;
sending a message to one or more provider front-end devices associated with the provider at different provider sites;
recording details of the triggering event in a database;
sending a question to the user front-end device associated with the triggering event;
sending an offer to the user frontend device associated with the triggering event.

9. The networked application of claim 8 wherein the message sent to the user front-end device includes a personal message to the user associated with the user front-end device.

10. The networked application of claim 8 wherein the message sent to the user front-end device includes situational information specific to the provider site.

11. The networked application of claim 8 wherein the message sent to any one of the provider front-end devices includes details of the triggering event.

12. The networked application of claim 8 wherein the message sent to any one of the provider front-end devices includes details of the user.

13. The networked application of claim 8 the question sent to the user of front-end device associated with the triggering event comprises a request for feedback about user experience associated the trigging event.

14. The networked application of claim 1 wherein the networked back-end further comprises:
a user application server operating on a WAN, wherein the user application server communicates with each of the plurality of user front-end devices to interface with the user front-end application operating thereon;
a provider application server operating on the WAN, wherein the provider application server communicates with each of the plurality of provider front-end devices to interface with the provider front-end application operating thereon; and,
a database server operating on the WAN, wherein the database server communicates with each of the user application server and the provider application server and is operable to store both user and provider date thereon.

15. A method comprising:
operating a user front-end application on a plurality of user front-end devices;
operating a provider front-end application on a plurality of provider front-end devices;
operating a networked back-end to interface with the user front-end application of each of the plurality of user front-end devices and with the provider front-end application of each of the plurality of provider devices;
associating a user ID with the operation of each of the plurality of user front-end applications;
associating a provider ID with the operation of each provider front-end device wherein the provider ID is further associated with a unique provider site;
detecting triggering events by operating the networked back-end to monitor each of the plurality of user front-end devices, and each of the plurality of provider front-end devices to detect an interaction between the user and a provider site.

16. The method of claim 15 wherein each user front-end device incudes a GPS device operating thereon further comprising:
storing a geo-location of each provider site on the networked back-end;
operating the user front-end application to read a geo-location from the GPS device
transmitting the geo-location of each front-end device to the networked back-end; and,
operating the networked back-end to compare the geo-location of each user front-end device with the geo-location of each provider sites and to generate a triggering event when a geo-location of a user front-end device is matched to a geo-location of a provider site.

17. The method of claim 15 wherein in response to detecting a triggering event the networked application operates to perform any one of the steps of:
sending a message to the user front-end device associated with the triggering event;
sending a message to one or more provider front-end devices associated with the provider site associated with the triggering event;
sending a message to one or more provider front-end devices associated with the provider at different provider sites;
recording details of the triggering event in a database;
sending a question to the user front-end device associated with the triggering event;
sending an offer to the user frontend device associated with the triggering event.

18. The method of claim 17 wherein the question sent to the user of front-end device associated with the triggering event comprises a request for feedback about user experience associated the trigging event.
